(19) United States
(12) Patent Application Publication
(10) Pub. No.: US 2024/0385064 A1
(43) Pub. Date: Nov. 21, 2024

(54) MICROMECHANICAL PRESSURE SENSOR ELEMENT

(71) Applicant: Robert Bosch GmbH, Stuttgart (DE)

(72) Inventors: Heribert Weber, Nuertingen (DE); Peter Schmollngruber, Aidlingen (DE); Thomas Friedrich, Moessingen-Oeschingen (DE)

(21) Appl. No.: 18/692,654

(22) PCT Filed: Aug. 4, 2022
(86) PCT No.: PCT/EP2022/071909

§ 371 Date: Mar. 15, 2024

(30) Foreign Application Priority Data
Sep. 20, 2021 (DE) 10 2021 210 382.0

(51) Int. Cl. G01L 9/00

(52) U.S. Cl. CPC G01L 9/0072

(57) ABSTRACT

A micromechanical pressure sensor element. The micromechanical pressure sensor element includes: a substrate; and a layer structure formed on the substrate. The layer structure includes a top electrode, a bottom electrode, and a movable central electrode arranged between the top and bottom electrodes. The central electrode is formed in flat fashion without a stepped boundary section. The layer structure has a planar surface directly after the production of the central electrode.

### FIELD

The present invention relates to a micromechanical pressure sensor element.

The present invention also relates to a method for producing a micromechanical pressure sensor element.

### BACKGROUND INFORMATION

German Patent Application No. DE 10 2018 222 712 A1 describes a capacitive pressure sensor in which, when two pressure sensors coupled with respect to the cavity internal pressure are connected together in a Wheatstone bridge circuit, useful and reference capacitors are connected into a half-bridge or diagonal bridge arrangement.

### SUMMARY

It is an object of the present invention to provide an improved micromechanical pressure sensor element.

According to a first aspect of the present invention, the object may be achieved with a micromechanical pressure sensor element, comprising:
a substrate; and
a layer structure formed on the substrate, wherein the layer structure has a top electrode, a bottom electrode, and a movable central electrode arranged between the top and bottom electrodes, wherein the central electrode is formed in flat fashion without a stepped boundary section, and wherein the layer structure has a planar surface directly after the production of the central electrode.

Advantageously, a high flexibility is thereby exploited in order to dimension individual distances between layers of the layer structure and to obtain/create planar surfaces for the use of photolithography processes for creating structures with small lateral dimensions. As a result, a local contact between the etch stop layer and the movable central electrode can thereby be prevented. In this way, a process sequence is further achieved in which, by providing a planar surface which also results in a planar upper side of the central electrode, fine structures can be realized in or on the surface, without having to fear lacquer cracks or lacquer-free areas and/or different lacquer thicknesses in the region of discontinuities, edges or topographies on the surface.

In this way, for example, a differential-capacitive pressure sensor can be produced. By interconnecting in a Wheatstone bridge circuit two proposed pressure sensor elements which are arranged adjacent to one another and whose cavities are optionally connected via a pressure compensation channel, a full bridge with four variable useful capacitances can be provided and a maximum sensitive pressure measurement can be realized.

Compared to the connection of comparable useful capacitances in a half-bridge or diagonal bridge arrangement, a doubling and a linearization of the electrical bridge output signal can thereby advantageously be achieved, which simultaneously also means a higher pressure sensitivity over an additional pressure range. Conversely, with a comparable electrical bridge signal, the useful capacitances and thus also the lateral geometric dimensions of differential-capacitive pressure sensors can be designed smaller than in a full-bridge arrangement.

According to a second aspect of the present invention, the object may be achieved by a method for producing a micromechanical component, comprising the steps of:
providing a substrate; and
providing a layer structure arranged on the substrate, wherein a top electrode, a bottom electrode and a movable central electrode arranged between the top and bottom electrodes are formed for the layer structure, wherein the central electrode is formed in flat fashion without a stepped boundary section, and wherein the layer structure is formed directly after production of the central electrode with a planar surface.

Preferred developments of the micromechanical pressure sensor element are disclosed herein.

In an advantageous development of the micromechanical pressure sensor element of the present invention, the layer structure has an etch stop layer, wherein a lateral distance between the etch stop layer and the central electrode is formed in a defined manner. In this way, an electrode surface of the central electrode is dimensioned in a defined manner and an electrode surface as large as possible and an optimized sensing characteristic of the pressure sensor element are provided without there being a need to fear mechanical contact between the electrode surface and the etch stop layer during pressure measurement.

In a further advantageous development of the micromechanical pressure sensor element of the present invention, the lateral distance between the etch stop layer and the central electrode corresponds to the layer thickness of a third oxide layer of the layer structure.

In a further advantageous development of the micromechanical pressure sensor element of the present invention, a second oxide layer is arranged between the third oxide layer and the etch stop layer.

In a further advantageous development of the micromechanical pressure sensor element of the present invention, by means of the second oxide layer, the central electrode is designed in a defined manner to be thicker than the etch stop layer.

In a further advantageous development of the micromechanical pressure sensor element of the present invention, the second oxide layer and the etch stop layer have been deposited one after the other and structured together in one process step. An electrode thickness can advantageously be dimensioned in this way.

In a further advantageous development of the micromechanical pressure sensor element of the present invention, by a separate structuring of the second oxide layer, a lateral distance between the etch stop layer and the central electrode is greater than a layer thickness of the third oxide layer.

In a further advantageous development of the micromechanical pressure sensor element of the present invention, by means of a defined layer thickness of the third oxide layer, a distance between the movable central electrode and the bottom electrode is defined. In this way, an electrode spacing between the movable central electrode and the bottom electrode is set.

In a further advantageous development of the micromechanical pressure sensor element of the present invention, by means of a layer thickness of a fourth oxide layer, a distance between the movable central electrode and the top electrode is defined.

In a further advantageous development of the micromechanical pressure sensor element of the present invention, layer thicknesses of the third and the fourth oxide layer have been formed independently of one another.

In a further advantageous development of the micromechanical pressure sensor element of the present invention, thicknesses of the third and fourth oxide layers are such that, in the event of a zero adjustment and/or in an idle state, a capacitance between the top electrode and the central electrode is essentially equal to a capacitance between the central electrode and the bottom electrode. This is intended to produce as small an electrical offset signal as possible in a Wheatstone bridge circuit consisting of two pressure sensor elements in the idle state (no pressure measurement) which advantageously needs to be electronically adjusted or compensated for only slightly.

The present invention is described in detail below with further features and advantages on the basis of several figures. Identical or functionally identical elements have the same reference signs. The figures are intended in particular to illustrate the main features of the present invention and are not necessarily to scale. For better clarity, it can be provided that not all reference signs are shown in all of the figures.

### BRIEF DESCRIPTION OF THE DRAWINGS

FIG. 1 shows a cross-sectional view of an embodiment of a conventional micromechanical pressure sensor element.

FIGS. 2-15 show representations of process steps for producing an example micromechanical pressure sensor element according to the present invention.

FIG. 16 shows an electrical equivalent circuit diagram of a Wheatstone bridge circuit which can be realized from an interconnection of membranes of two proposed pressure sensor elements.

FIG. 17 shows the electrical equivalent circuit diagram of FIG. 16 is a simplified representation.

FIG. 18 shows a basic sequence for producing a provided micromechanical pressure sensor element according to an example embodiment of the present invention.

### DETAILED DESCRIPTION OF EXAMPLE EMBODIMENTS

A main feature of the present invention is a production of an improved micromechanical pressure sensor element, which can be used, for example, in the form of a differential-capacitive pressure sensor.

The term “functional layer” is preferably understood below to mean a polysilicon layer. Furthermore, the term “oxide layer” is understood below to mean a SiO₂ layer. Alternative compositions of the aforementioned layers are also possible.

In order to increase the electrical conductivity, the functional layers made of polysilicon can be specifically provided with a dopant used as standard in semiconductor technology.

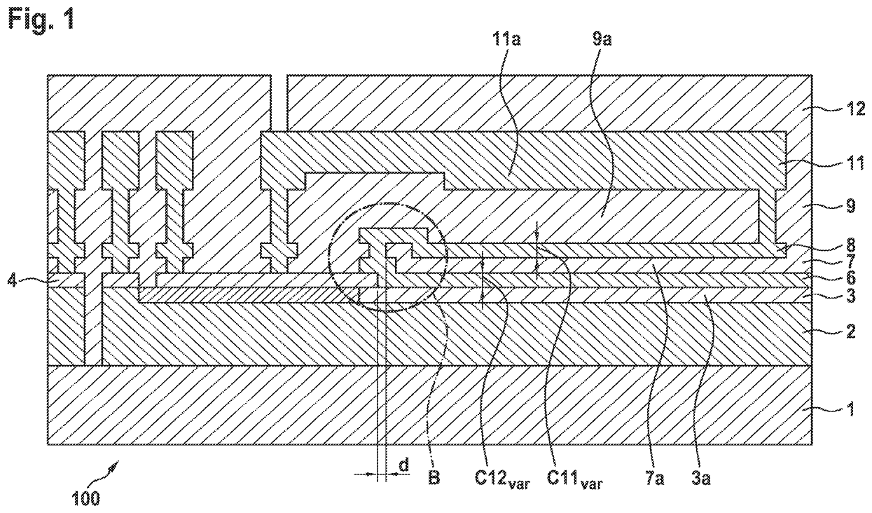

FIG. 1 shows a cross-sectional view of a conventional micromechanical pressure sensor element 100. It can be seen that in the course of a process sequence an edge is formed on an etch stop layer 4, which edge extends further up into a central electrode. This occurs in that the etch stop layer 4 is structured in the process sequence in order to expose the bottom electrode 3a in a first functional layer 3. For the purpose of sealing with respect to the cavity region 11a, the etch stop layer 4 is designed to overlap the bottom electrode 3a so that a first oxide layer 2 is not attacked during the etching-out of the cavity region 11a. In this way, a topography is generated which continues into the further layer structure. If fine, micrometer- and/or submicrometer-sized structures are to be created in the further layer structure, a thin photoresist/photoresist film must generally be provided on the surface, which is standardly applied in a spinning-on process and can tear off/tear open at the said topography, whereby areas are disadvantageously formed which are not covered or only insufficiently covered with photoresist.

FIG. 1 thus shows a basic structure of a conventional pressure sensor element 100. Subsequently, a sacrificial layer etching, a closure of the etching access(es) for the sacrificial layer etching and a production of a wiring level for electrical connections of the pressure sensor element 100 would also take place. However, for reasons of better clarity, these working steps are not shown in the figures.

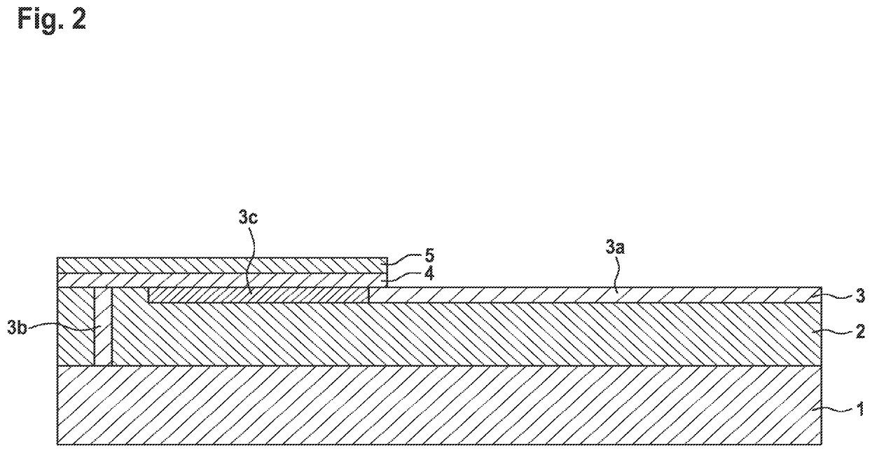

Process steps for producing a micromechanical pressure sensor element 100 improved in the above respect are explained below with reference to a plurality of figures. FIG. 2 shows that firstly a first oxide layer 2 is deposited on a silicon substrate 1, with recesses being created in the first oxide layer 2, which recesses can in part completely penetrate the first oxide layer 2.

After this, the full-surface deposition of a first functional layer 3 takes place, which completely fills the recesses with silicon. With the aid of a polishing step (for example, in the form of a Si CMP step), the deposited first functional layer 3 can be removed from the surface in such a way that silicon remains only in the recesses and a planar surface results. In this way, for example, at least one bottom electrode 3a, at least one substrate contact structure 3b and/or at least one conductor track 3c can be provided.

An etch stop layer 4 (for example, a silicon-rich silicon nitride layer) is now deposited and structured onto the surface prepared in this way. Here, the etch stop layer 4 is removed from the first functional layer 3 in the region of the useful capacitance. This exposed region is provided later for forming the bottom electrode structure of the differential capacitor structure. During removal of the etch stop layer 4, it is provided that it overlaps the edge region of the bottom electrode structure in a defined manner or at least adjoins it in a flush and media-tight manner.

If this is not the case, during a later sacrificial layer etching process SiO₂ beneath the etch stop layer 4 and/or the bottom electrode structure can be unintentionally removed. In this way, the etch stop layer 4 in combination with the bottom electrode structure made of polysilicon in the cavity region 11a prevents an etching attack on the underlying oxide layer during a sacrificial layer etching process.

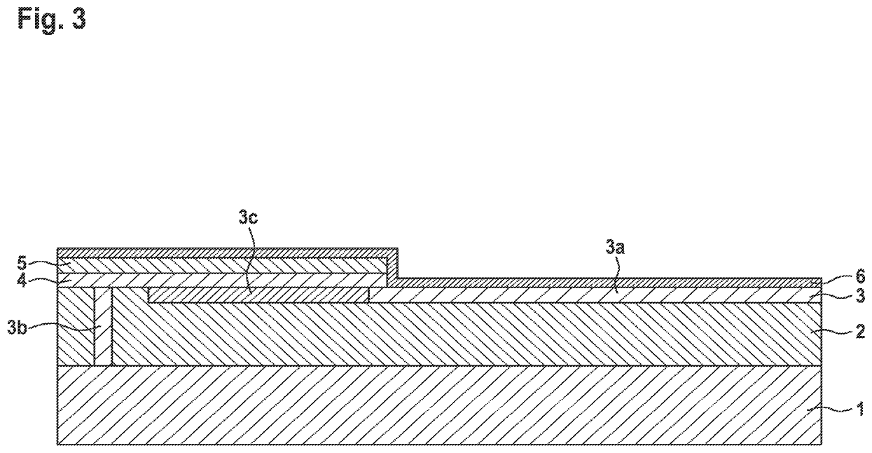

In the cross-sectional view in FIG. 2 and FIG. 3, it can be seen that a second oxide layer 5, which is structured together with the etch stop layer 4 in an etching process, can optionally be deposited on the etch stop layer 4. With the aid of this second oxide layer 5, it is possible to dimension the thickness of the subsequent central electrode 7a in such a way that its thickness can be selected to be greater than a thickness of the etch stop layer 4. After the structuring of the second oxide layer 5 together with the etch stop layer 4, a third oxide layer 6 is deposited, as indicated in the cross-sectional view in FIG. 3. The thickness of the third oxide layer 6 defines a later distance between the central electrode and the bottom electrode of the micromechanical component.

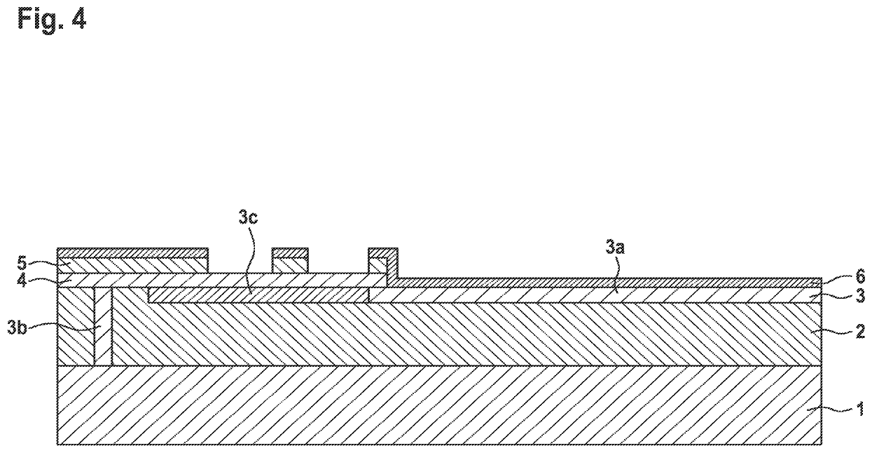

As can be seen in FIG. 4, the second and third oxide layers 5, 6 can now be structured in such a way that the etching process used for this purpose stops at the etch stop layer 4. In this way, it is possible, for example, together with functional layers still to be deposited subsequently, to define a cavity region with lateral etch stop structures or boundaries and/or to realize anchoring surfaces for anchoring structures of the top electrode structure and/or of the membrane.

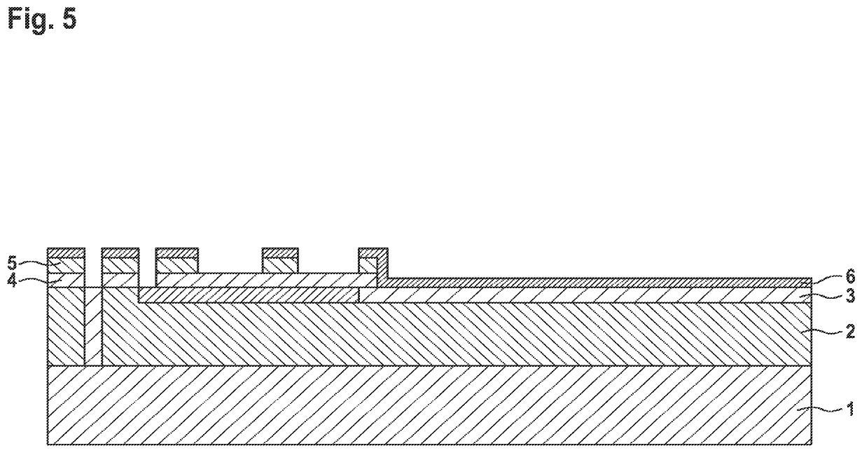

Next, as indicated in FIG. 5, recesses through the second and third oxide layers 5, 6 and the etch stop layer 4 can be created in which the etching process stops at the first functional layer 3. The recesses produced in this way can serve to produce at least one electrical contact between substrate contact structures 3b or conductor tracks 3c in the first functional layer 3 and structures/conductor tracks in a further functional layer.

Alternatively, the recesses through the etch stop layer 4 for producing at least one electrical contact between substrate contact structures 3b and/or conductor tracks 3c in the first functional layer 3 and structures/conductor tracks in a further functional layer can already be produced during removal of the etch stop layer 4 from the first functional layer 3 in the region of the useful capacitance. In this way, the above-described etching step can be omitted, and the contact structures mentioned can also be exposed/created during the creation of the recesses in the second and third oxide layers 5, 6 for lateral etch stop structures or boundaries and/or anchoring surfaces for anchoring structures of the top electrode structure and/or of the membrane.

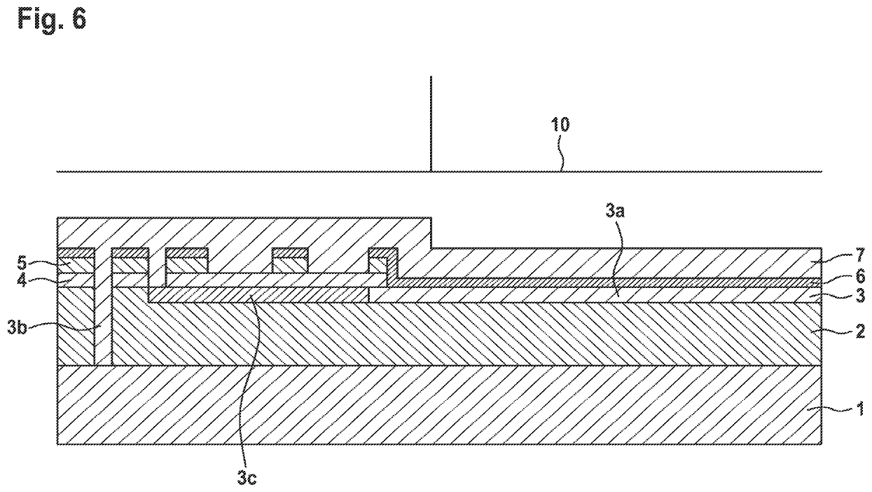

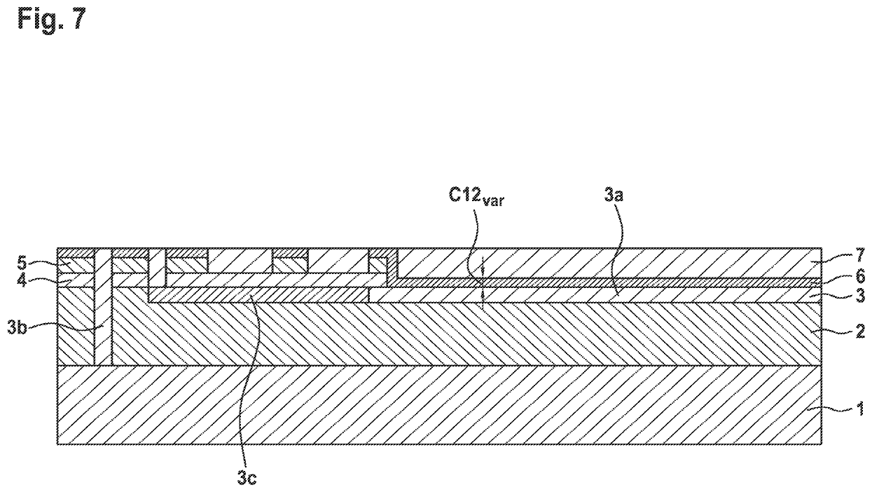

The cross-sectional view in FIG. 6 shows a deposition of a second functional layer 7, by means of which electrical contacts, for example, to substrate contact structures 3b or conductor tracks 3c in the first oxide layer 2 can also be formed. After the second functional layer 7 has been deposited, it is thinned back with the aid of a polishing process or planarization step 10 (for example, a CMP process 10) in such a way that the polishing process 10 stops at the third oxide layer 6 and a planar surface is created, wherein polysilicon remains only in previously created depressions, as indicated in FIG. 7. FIG. 7 shows the thereby produced planar surface of the second functional layer 7. As a result, a topography can be prevented in this way from extending further into further layers in the subsequent electrode structure of the second functional layer 7, as shown in FIG. 1. As a result, a topography of the central electrode 7a in the region of an edge of the etch stop layer 4 can thereby be prevented, whereby a snagging between the central electrode 7a and an edge of the etch stop layer 4 can advantageously be avoided.

The planarization by means of the polishing process 10 creates on the one hand a planar surface which is advantageous for subsequent lithography processes. In addition, in this way, the movable central electrode 7a is provided in a flat form without stepped boundary sections or without topography.

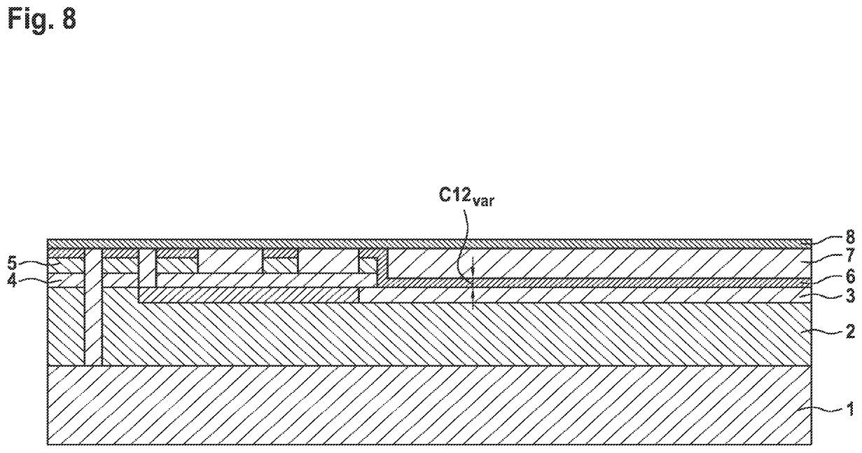

After this, as indicated in FIGS. 8 to 12, a fourth oxide layer 8 is deposited and structured, a third functional layer 9 is deposited and structured (in the third functional layer 9, the subsequent top electrode 9a of the differential capacitor structure is formed), a fifth oxide layer 11 is deposited, optionally planarized and structured, and finally a fourth functional layer 12 is deposited and structured.

By structuring the aforementioned layers, it can be achieved that polysilicon conductor tracks, contacts between the individual polysilicon layers or planes or conductor tracks, fastening or anchoring regions for the membrane and the electrodes, accesses for sacrificial layer etching in the cavity region beneath the membrane, structures for fastening the central electrode to the membrane, etc. can be created.

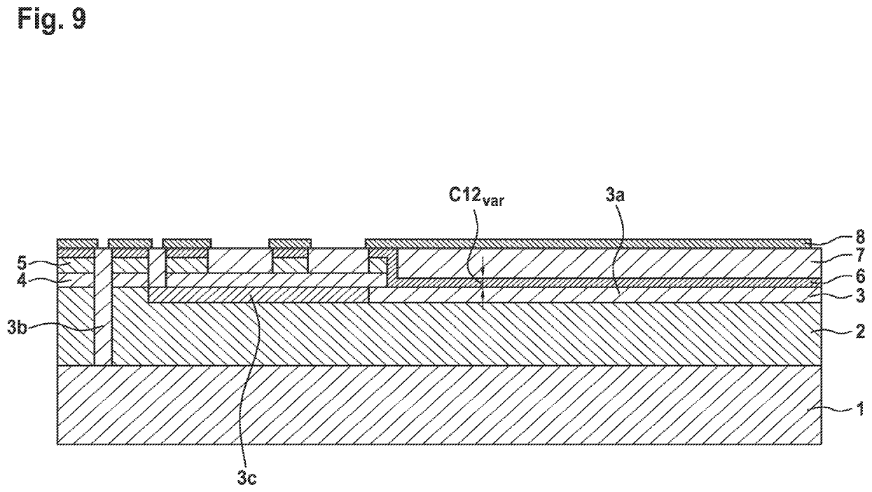

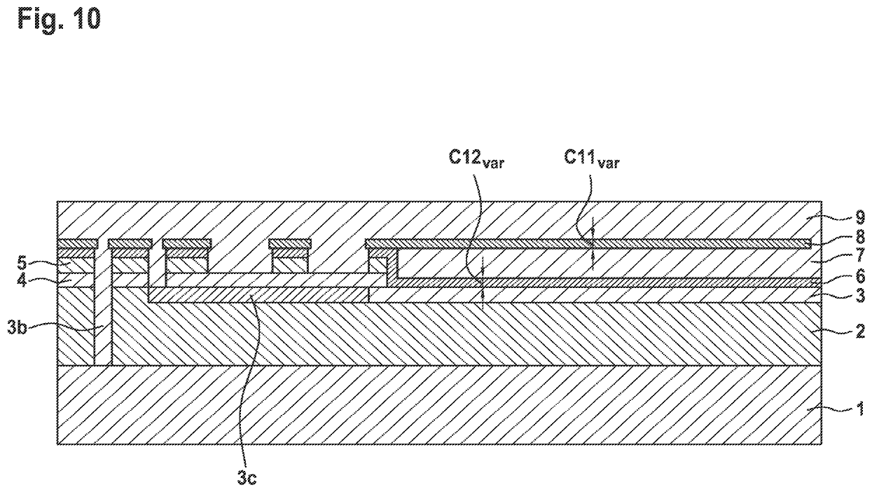

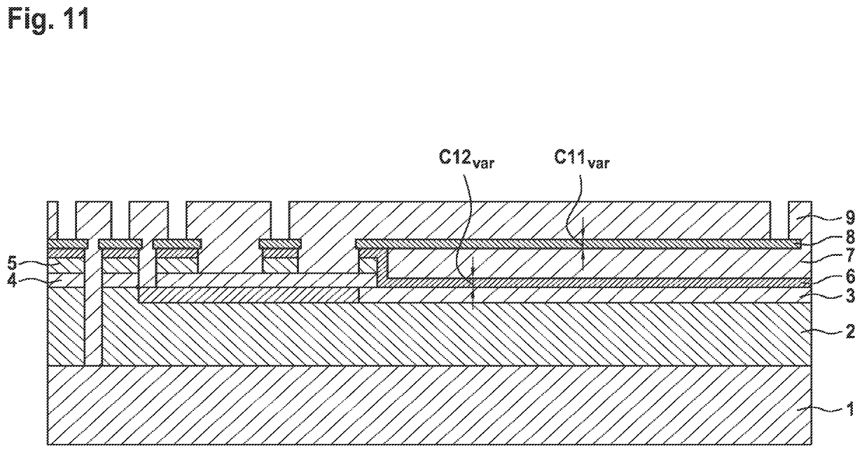

FIGS. 8 and 9 indicate that a fourth oxide layer 8, which defines a subsequent distance between the movable central electrode 7a and the top electrode 9a, is deposited on the planar surface with the second functional layer 7 and the third oxide layer 6. The fourth oxide layer 8 can subsequently optionally be structured together with the second and third oxide layers 5, 6. The regions exposed thereby can further serve for the production of electrical contact structures and/or anchoring structures. In the next process step, a third functional layer 9 can then be deposited, optionally planarized and structured in such a way that the etching process stops at subregions of the fourth oxide layer 8, as indicated in the cross-sectional views in FIGS. 10 and 11.

The third functional layer 9 fills exposed regions of the fourth oxide layer 8 and serves, among other things, to create the top electrode/electrode structure 9a and also the production of a subsection of the connecting structure by which the movable central electrode 7a is mechanically and electrically connected or fastened to the subsequent membrane.

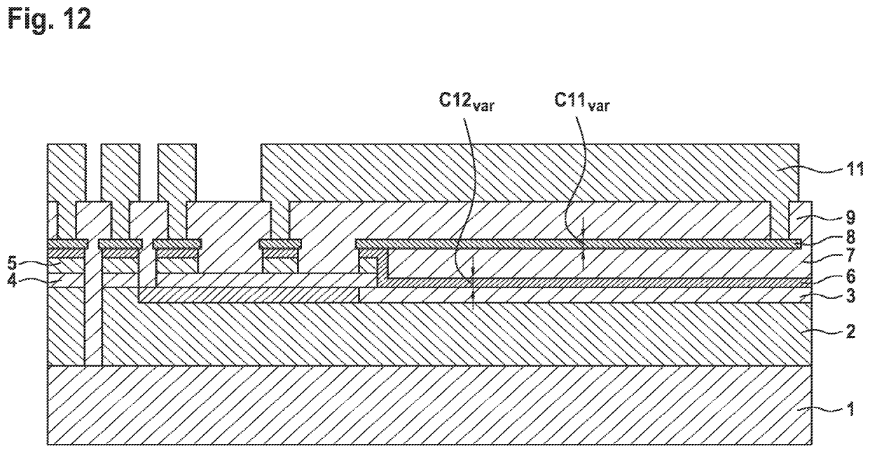

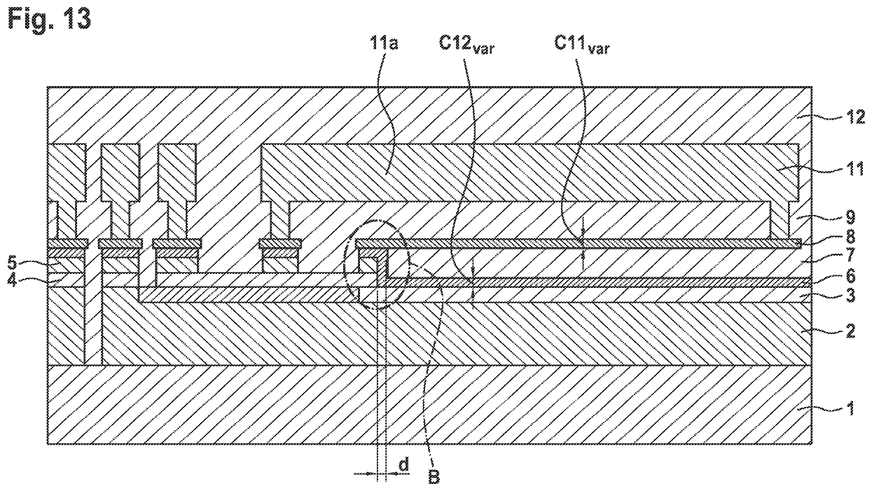

Next, as indicated in FIG. 12, a fifth oxide layer 11 is deposited on the third functional layer 9 and into exposed regions therein, optionally planarized and then structured. The etching process used stops at the third functional layer 9. After this, as indicated in FIG. 13, a fourth functional layer 12 is deposited on the fifth oxide layer 11 and into exposed regions therein. This fifth functional layer 12 fills the exposed regions of the fifth oxide layer 11 and serves, among other things, to create the membrane or membrane structure and also to produce a second subsection of the connecting structure by which the central electrode 7a is mechanically and electrically connected to or fastened to the membrane.

As can also be seen in FIG. 13, in this structuring a distance of the top electrode 9a from the central electrode 7a can be set via a layer thickness of the fourth oxide layer 8 and a distance of the movable central electrode 7a from the bottom electrode 3a can be set via a layer thickness of the third oxide layer 6, independently of one another.

Alternatively, before the deposition of the fourth functional layer 12 it is also possible to deposit a further functional layer and to planarize it in such a way that a planar surface is created and the polishing process 10 stops at the fifth oxide layer 11. By filling the recesses or depressions in the fifth oxide layer 11 in this way, undesired steps or topographies can be prevented from occurring in the region of the pressure sensor membrane and/or its clamping, and thereby, for example, impairing the mechanical stability of the membrane stability.

After removal of the oxide layers (sacrificial layers) from the cavity region 11a and completion of the pressure sensor element 100, it can be achieved by the independent selection of the thickness of the third and the fourth oxide layers 6, 8 that, in the case of an atmospheric pressure or a “standard pressure” or a “reference pressure” applied to the membrane, a central position of the movable central electrode 7a between the top and bottom electrodes 9a, 3a is achieved.

In FIG. 13, it can be seen within the highlighted region B that the distance d between the subsequent central electrode 7a and the etching edge surrounding it in the etch stop layer 4 and also the optional second oxide layer 5 is predetermined by the thickness of the third oxide layer 6.

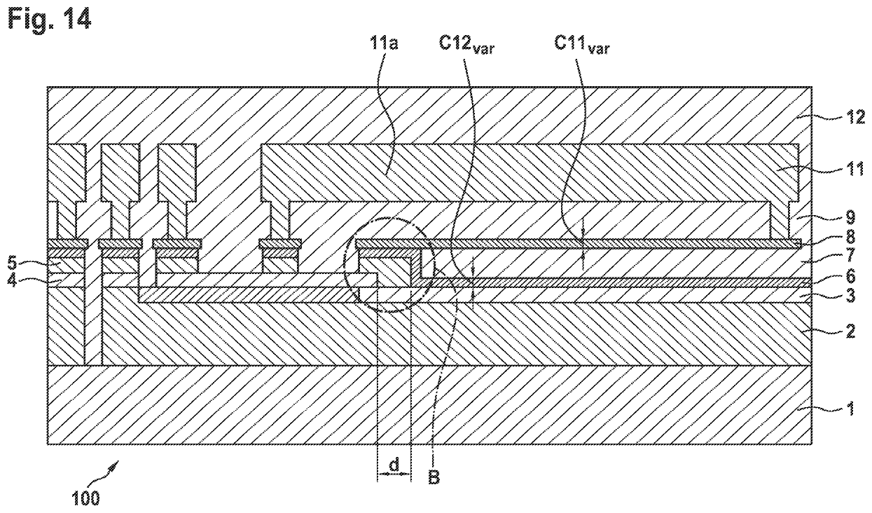

FIG. 14 shows a variant of the pressure sensor element 100 in which this distance d is greater in comparison to FIG. 13. For this purpose, the second oxide layer 5 is not structured together with the etch stop layer 4, but only after the structuring of the etch stop layer 4. In order to be able to prevent a step formation, as shown in FIG. 1, at the edge of the central electrode 7a, there are two possibilities.

In the first possibility, the second oxide layer 5 is deposited and thinned back before the structuring by means of a polishing process 10 in such a way that a planar surface is created and the second oxide layer 5 on the etch stop layer 4 has the desired target thickness.

In the second possibility, an additional oxide layer is deposited and this is thinned back with the aid of a polishing process, with a stop on the surface of the etch stop layer 4, in such a way that here too a planar surface is created and regions with no etch stop layer are filled with oxide material. After this, the second oxide layer 5 is then deposited in such a way that the desired layer thickness on the etch stop layer 4 results. Next, the structuring of the additional and of the second oxide layer would then be carried out and the further layer structure created.

In the differential-capacitive pressure sensor element shown here, it is thus advantageously possible to achieve planar and arbitrarily thick electrode structures without disturbing steps, any distances desired between the central electrode and the upper and the lower electrodes, as well as a central positioning of the movable central electrode 7a between the top and bottom electrodes, which simplifies a calibration of the pressure sensor element 100 in the case of a “normal pressure” or “reference pressure” applied to the membrane.

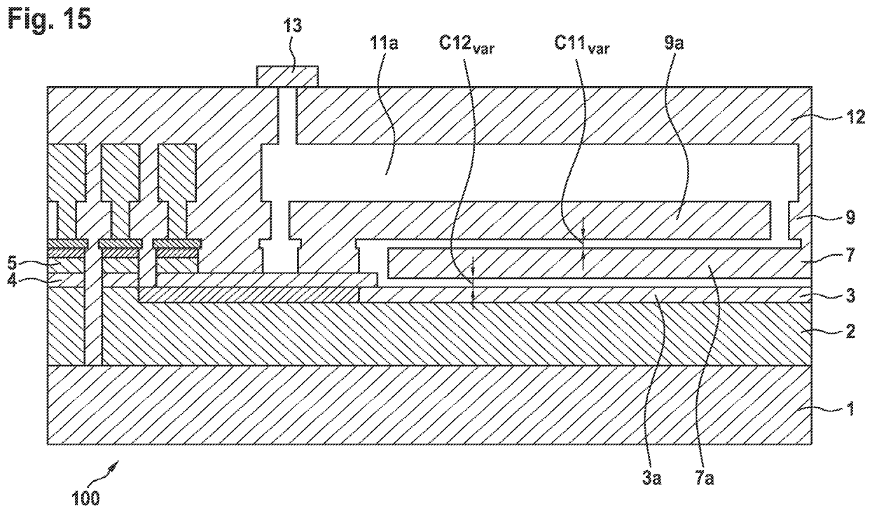

FIG. 15 shows the micromechanical pressure sensor element 100 after removal of the sacrificial oxide layers in the cavity region 11a beneath the membrane and a closure element 13 used to close an etching access opening. In the case of an atmospheric pressure applied to the diaphragm with the central electrode 7a and a central position of the central electrode 7a being established here between the adjacent electrodes 9a, 3a, the useful capacitances C11ᵥₐᵣ and C12ᵥₐᵣ shown here would be of the same magnitude. This makes it possible to simplify the calibration of the pressure sensor element 100 to a “standard pressure” or a “reference pressure.” In this way, an electrical offset signal which is as small as possible is to be generated which advantageously only needs to be compensated for electronically to a minor extent.

However, the central electrode 7a can alternatively be formed in flat fashion without a stepped boundary section, but also segmented or divided into segments and provided with through-holes, whereby a faster etching of the sacrificial oxide layers is advantageously supported.

In a similar manner, the top electrode 9a can also be formed in flat fashion without a stepped boundary section and segmented or divided into segments and provided with through-holes, whereby a faster etching of the sacrificial oxide layers is supported.

Furthermore, in the structure described, anchoring structures for the top electrode and the membrane can be located, for example, on the etch stop layer 4, for example, can be electrically connected via contact hole structures to the polysilicon conductor track plane beneath the etch stop layer 4, and also form lateral etch stop structures around the cavity region 11a. In this way, it is advantageously possible to produce a sensitive pressure sensor element 100 which, with a second, identically constructed pressure sensor element, a pressure coupling of the two cavity regions and a connection to form a full Wheatstone bridge, supports a maximally sensitive pressure measurement.

For better clarity, the representation of an additional wiring level for the electrical connection of the electrode structures has been dispensed with in FIG. 15. After an etching access opening has been closed by the closure element 13, at least one additional wiring level can be further created by standard methods and components for the electrical connection of the electrode structures can be created.

The micromechanical pressure sensor element 100 produced using the proposed method can be a capacitive pressure sensor, for example, as explained above. Other implementations, not shown in the figures, of the proposed micromechanical component 100, such as a microphone, a piezoresistive pressure sensor, an acceleration sensor, a yaw rate sensor, etc., are also possible.

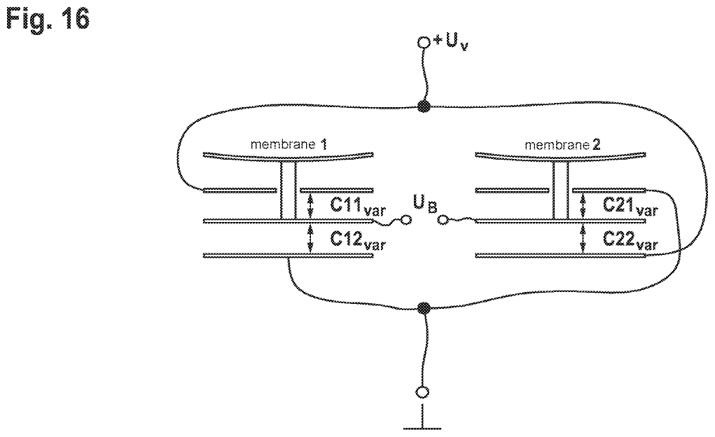

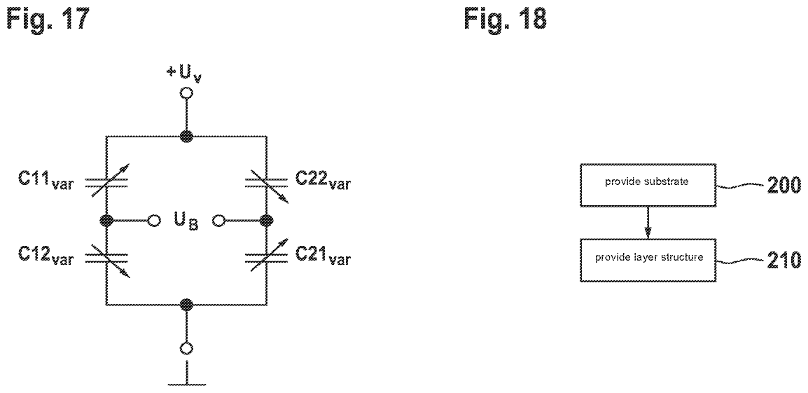

FIGS. 16, 17 show by way of example an electrical interconnection of two differential-capacitive pressure sensors in a Wheatstone full-bridge arrangement, wherein the left-hand section in each case represents a first proposed pressure sensor element 100 and the right-hand section in each case represents a second pressure sensor element 100 electrically connected to the first pressure sensor element 100.

FIG. 18 shows a basic sequence of a method for producing a proposed micromechanical pressure sensor element 100.

In a step 200, a substrate 1 is provided.

In a step 210, a layer structure arranged on the substrate 1 is provided, wherein a top electrode 9a, a bottom electrode 3a and a movable central electrode 7a arranged between the top and bottom electrodes is formed for the layer structure, wherein the central electrode 7a is formed in flat fashion without a stepped boundary section and, during the production of the central electrode, a surface planar over its entire surface is created.

1-13. (canceled)

14. A micromechanical pressure sensor element, comprising:
a substrate; and
a layer structure formed on the substrate, wherein the layer structure has a top electrode, a bottom electrode, and a movable central electrode arranged between the top and bottom electrodes, wherein the central electrode is formed in flat fashion without a stepped boundary section, and wherein the layer structure has a planar surface directly after production of the central electrode.

15. The micromechanical pressure sensor element according to claim 14, wherein the layer structure has an etch stop layer, wherein a lateral distance between the etch stop layer and the central electrode is formed in a defined manner.

16. The micromechanical pressure sensor element according to claim 15, wherein the lateral distance between the etch stop layer and the central electrode corresponds to a layer thickness of a third oxide layer of the layer structure.

17. The micromechanical pressure sensor element according to claim 16, wherein a second oxide layer is arranged between the third oxide layer and the etch stop layer.

18. The micromechanical pressure sensor element according to claim 17, wherein, using the second oxide layer, the central electrode is configured in a defined manner to be thicker than the etch stop layer.

19. The micromechanical pressure sensor element according to claim 17, wherein the second oxide layer and the etch stop layer were deposited one after the other and structured together in one process step.

20. The micromechanical pressure sensor element according to claim 17, wherein using a separate structuring of the second oxide layer, a lateral distance between the etch stop layer and the central electrode is greater than a layer thickness of the third oxide layer.

21. The micromechanical pressure sensor element according to claim 16, wherein a distance between the movable central electrode and the bottom electrode is defined using a defined layer thickness of the third oxide layer.

22. The micromechanical pressure sensor element according to claim 14, wherein a distance between the movable central electrode and the top electrode is defined using a layer thickness of a fourth oxide layer.

23. The micromechanical pressure sensor element according to claim 22, wherein layer thicknesses of the third and fourth oxide layers were formed independently of one another.

24. The micromechanical pressure sensor element according to claim 21, wherein layer thicknesses of the third and fourth oxide layers are such that, in the event of a zero adjustment and/or in an idle state, a capacitance between the top electrode and the central electrode is equal to a capacitance between the central electrode and the bottom electrode.

25. A micromechanical pressure sensor device, comprising:
two micromechanical pressure sensor elements including:
a substrate, and
a layer structure formed on the substrate, wherein the layer structure has a top electrode, a bottom electrode, and a movable central electrode arranged between the top and bottom electrodes, wherein the central electrode is formed in flat fashion without a stepped boundary section, and wherein the layer structure has a planar surface directly after production of the central electrode
wherein cavity regions of the two micromechanical sensor elements have the same internal pressure due to a pressure coupling and which are connected to form a Wheatstone bridge.

26. A method for producing a micromechanical pressure sensor element, comprising the following steps:
providing a substrate; and
providing a layer structure arranged on the substrate, wherein a top electrode, a bottom electrode and a movable central electrode arranged between the top and bottom electrodes are formed for the layer structure, wherein the central electrode is formed in flat fashion without a stepped boundary section, and wherein the layer structure is formed with a planar surface directly after production of the central electrode.
